(19) United States
(12) Patent Application Publication
(10) Pub. No.: US 2023/0269657 A1
(43) Pub. Date: Aug. 24, 2023

(54) METHODS AND DEVICES FOR TRANSMITTING MEASUREMENT FEEDBACK IN WI-FI SENSING

(71) Applicant: HUAWEI TECHNOLOGIES CO., LTD., Shenzhen (CN)

(72) Inventors: Osama ABOUL-MAGD, Kanata (CA); Yan XIN, Kanata (CA); Jung Hoon SUH, Kanata (CA); Kwok Shum AU, Ottawa (CA)

(73) Assignee: HUAWEI TECHNOLOGIES CO., LTD., SHENZHEN (CN)

(21) Appl. No.: 17/678,235

(22) Filed: Feb. 23, 2022

(51) Int. Cl. H04W 48/16; H04W 24/10; H04L 5/00; H04B 7/06

(52) U.S. Cl. CPC H04W 48/16; H04W 24/10; H04L 5/0053; H04B 7/061; H04L 5/0094

(57) ABSTRACT

There is provided a method for providing a sensing initiator station with measurement feedback. The method includes broadcasting, by the sensing initiator station, a sensing announcement frame and broadcasting, by the sensing initiator station, a sensing sequence frame, the sensing sequence frame containing a reference sequence. The method further includes transmitting, by the sensing initiator station, a feedback request frame, the feedback request frame including station information indicating resources allocated for each participating station. The method further includes sending, by a responder station, a feedback frame to the sensing initiator, the feedback frame including an indicator corresponding to data contained in the feedback frame. There is also provided a device which includes a processor, and non-transitory computer readable memory having stored thereon machine readable instructions. The instructions, when executed by the processor configure the device to execute a method disclosed herein.

### CROSS-REFERENCE TO RELATED APPLICATIONS

This is the first application filed for the present disclosure.

### FIELD

The present disclosure pertains to the field of wireless communications, and in particular to techniques for transmitting measurement feedback in Wi-Fi sensing.

### BACKGROUND

The use of Wi-Fi radio frequency (RF) signals for the identification and recognition of human activities and other applications is a well-publicized topic.

One particular sensing method relies on the use of Wi-Fi channel state information (CSI) capabilities to monitor changes to the CSI sequence (which can include characteristics such as amplitude and phase, among others). Wi-Fi CSI was first introduced in IEEE 802.11n in the context of multiple-in multiple-out (MIMO).

CSI represents how an electrical signal propagates from the transmitter to the receiver, and combined effects including scattering, fading, and power decay with respect to a distance travelled by the signal. A CSI training sequence is a known sequence designed to measure the channel effect between the transmitter and the receiver. Changes to the CSI sequence can then be processed in order to identify certain events, for example human gestures or human identity, which may be reflected in the changes to the CSI sequence.

CSI can further be reflective of a wireless signal's propagation characteristics for the link from the transmitter to the receiver at certain carrier frequencies. CSI measurements include information when wireless signals transmit through surrounding objects and humans in time, frequency and spatial domains, and can be used for various wireless sensing applications. For example, amplitude variations in CSI in the time domain may show different patterns for different humans, activities or gestures; phase shifts in CSI in the spatial and frequency domains (such as transmit/receive antennas and carrier frequencies) can be related to signal transmission delay and direction which can be used for human localization and tracking; and phase shifts in CSI in the time domain may demonstrate different dominant frequency components which can be used to estimate breathing rate. However some of these evaluations may be limited.

Accordingly, there is a need for new methods and devices to better harness the use of CSI in providing feedback information, that are not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide methods and devices for transmitting measurements feedback in Wi-Fi sensing.

An aspect of the disclosure provides for a method of providing a sensing initiator station with measurement feedback. The method includes broadcasting, by the sensing initiator station, a sensing announcement frame. The method further includes broadcasting, by the sensing initiator station, a sensing sequence frame, the sensing sequence frame containing a reference sequence. The method further includes transmitting, by the sensing initiator station, a feedback request frame, the feedback request frame including station information indicating resources allocated for each participating station. The method further includes receiving, from a responder station, a feedback frame to the sensing initiator, the feedback frame including an indicator corresponding to data contained in the feedback frame.

In some embodiments the method further includes receiving, from the responder station, at least one of an indication to participate, and an indication to not participate. In some embodiments the at least one of the indication to participate and the indication to not participate is sent one of before the broadcasting of the sensing sequence frame, and after the broadcasting of the sensing sequence frame. In some embodiments the sensing initiator station is one of an access point station, and a non-access point station. In some embodiments the sensing announcement frame includes at least one station ID for at least one station. In some embodiments the reference sequence is used by a participating station to estimate at least one of channel state information (CSI) channel state information (CSI), angle of arrival (AoA), angle of departure (AoD), time of flight (ToF), time of arrival (ToA), and time of departure (ToD). In some embodiments the feedback request frame is a trigger frame. In some embodiments the feedback frame is an action frame. In some embodiments the feedback frame includes at least one of sensing measurements feedback, an indication that no measurements are reported, an indication to participate, and an indication to not participate. In some embodiments the sensing announcement frame is a null data packet announcement (NDPA) frame.

An advantage of embodiments can be that they may provide a feedback frame protocol for sending sensing measurements information from a responder station back to an initiator station. Further, the frame format presented herein may be used to start the sensing procedure in the downlink (DL) and the uplink (UL) directions. According to some embodiments, the frame format for the feedback frame disclosed herein is based on action frames, which can allow for easier integration into existing architectures. Moreover, some embodiments of the present disclosure define feedback types which may provide greater usability.

Another aspect of the disclosure provides for a device. The device includes a processor, and non-transitory computer readable memory having stored thereon machine readable instructions which when executed by the processor configure the device to execute the methods disclosed herein. For example, upon execution by the processor, the instructions configure the device to broadcast a sensing announcement frame and broadcast a sensing sequence frame, the sensing sequence frame containing a reference sequence. Upon execution by the processor, the instructions can further configure the device to transmit a feedback request frame, the feedback request frame including station information indicating resources allocated for each participating station. Upon execution by the processor, the instructions can further configure the device to receive a feedback frame from a responder station, the feedback frame including an indicator corresponding to data contained in the feedback frame.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates a method for providing a sensing initiator station with measurement feedback, according to embodiments of the present disclosure.

FIG. 2 illustrates a call flow based on the method of FIG. 1, according to embodiments of the present disclosure.

FIG. 3 illustrates another call flow, according to embodiments of the present disclosure.

FIG. 4 illustrates another alternative call flow, according to embodiments of the present disclosure.

FIG. 5 illustrates a format for a feedback request frame, according to embodiments of the present disclosure.

FIG. 6 illustrates a format for feedback frame, according to embodiments of the present disclosure.

FIGS. 7A and 7B illustrate action frame formats, according to embodiments of the present disclosure.

FIG. 8 illustrates a block diagram of an example electronic device used for implementing methods disclosed herein, according to embodiments of the present disclosure.

It will be noted that throughout the appended drawings, like features are identified by like reference numerals.

### DETAILED DESCRIPTION

Embodiments of the present disclosure describe techniques for transmitting measurement feedback in Wi-Fi sensing. A sensing session begins with a sensing initiator station (which may be an access point station or a non-access point station) broadcasting a sensing announcement frame. The sensing announcement frame may be similar to a null data packet (NDP) announcement (NDPA), as defined in the 802.11 standard. The sensing announcement may include, among other information, the respective station ID of stations invited to participate in the sensing session. As the sensing announcement is a broadcast message, it is received by all stations associated with the particular sensing initiator station. The sensing announcement is followed by a sensing sequence frame containing a reference sequence (which may be similar to an NDP). The sensing sequence is used by a participating station in order to estimate the channel state information (CSI). A feedback request frame is then transmitted by the sensing initiator station. The feedback request frame is a trigger frame which includes the station information which indicate resources allocated for each participating station for their respective transmission. Then the one or more participating stations respond by sending a feedback frame to the sensing initiator station. The feedback frame may be an action frame.

As may be appreciated by a person skilled in the art, CSI may reflect wireless signal propagation characteristics associated with a link between a transmitter and a receiver at, for example, certain carrier frequencies. CSI measurements may include information in time, frequency, and spatial domains. CSI measurements may be used for various wireless sensing applications.

As used herein, an initiator shall be taken to be similar in meaning to a sensing initiator or a sensing initiator station, and a responder shall be taken to be similar in meaning to a sensing responder or a sensing responder station.

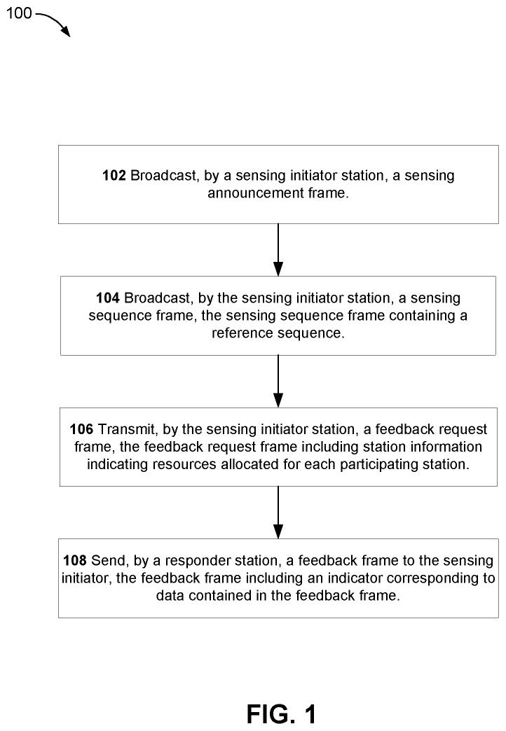

FIG. 1 is a flowchart of a method 100 of providing a sensing initiator station with measurement feedback according to embodiments of the instant disclosure. The method 100 involves, at step 102, broadcasting, by the sensing initiator station, a sensing announcement frame and at step 104, broadcasting, by the sensing initiator station, a sensing sequence frame, the sensing sequence frame containing a reference sequence. The method 100 further involves, at step 106, transmitting, by the sensing initiator station, a feedback request frame, the feedback request frame including station information indicating resources allocated for each participating station. The method 100 further involves, at step 108, sending, by a responder station, a feedback frame to the sensing initiator, the feedback frame including an indicator corresponding to data contained in the feedback frame.

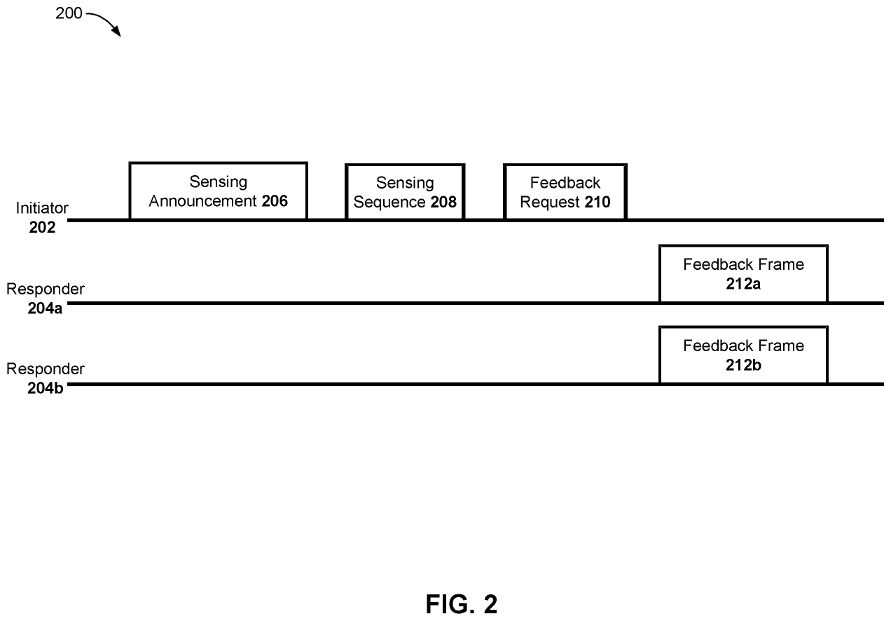

FIG. 2 is a depiction of the method 100 of FIG. 1, in which the method is depicted as a call flow 200. In the call flow 200, a sensing initiator 202 broadcasts a sensing announcement frame 206. The sensing initiator 202 then broadcasts a sensing sequence frame 208. The sensing initiator 202 then transmits a feedback request frame 210. Then responders 204a and 204b send respective feedback frames 212a and 212b to the sensing initiator 202. While only two responders are depicted in the call flow 200, it will be reasonably understood that the number of responders may vary in any given network or configuration.

In some embodiments the sensing announcement frame includes at least one station ID for at least one station which is being asked for participation in the sensing session or sensing feedback session.

In some embodiments the method 100 further includes sending, by the responder station to the initiator station, at least one of an indication to participate and an indication to not participate. The provision of a participating or non-participating indicator may allow the initiator station to be informed of the willingness of a responder station to participate in a pending sensing session. Each responder station may elect to send an indication to participate, or not participate to the initiator station. The indications to participate or not participate may be action frames of the same sensing category. However, these indications may be configured in a variety of different formats as would be readily understood by a worker skilled in the art.

The call flow 200 may be a downlink (DL) procedure. As may be appreciated by a person skilled in the art, a DL procedure may refer to embodiments in which one or more sensing frames (for example, sensing sequence frame 208) may be carried in a sensing physical protocol data unit (PPDU) and transmitted by the sensing initiator 202 toward the sensing responders 204a and 204b. Accordingly, the DL direction may refer to the direction toward the sensing responders 204a and 204b from the sensing initiator 202.

Similarly, an uplink (UL) procedure may refer to embodiments in which one or more sensing frames may be carried in a sensing PPDU and transmitted by the one or more sensing responders (204a and 204b) toward the sensing initiator 202. The UL direction may refer to the direction toward the sensing initiator 202 from the sensing responders 204a and 204b.

In some embodiments at least one of the indications to participate and the indication to not participate is sent before the broadcasting of the sensing sequence frame 208. This timing of the transmission of the indication may allow for a sensing initiator 202 to identify early on which responder stations are willing participate in the sensing session, thereby potentially allowing the sensing initiator to transmit the sensing sequencing frame 208 and feedback request frame 210 only to the responder stations that have indicated participation.

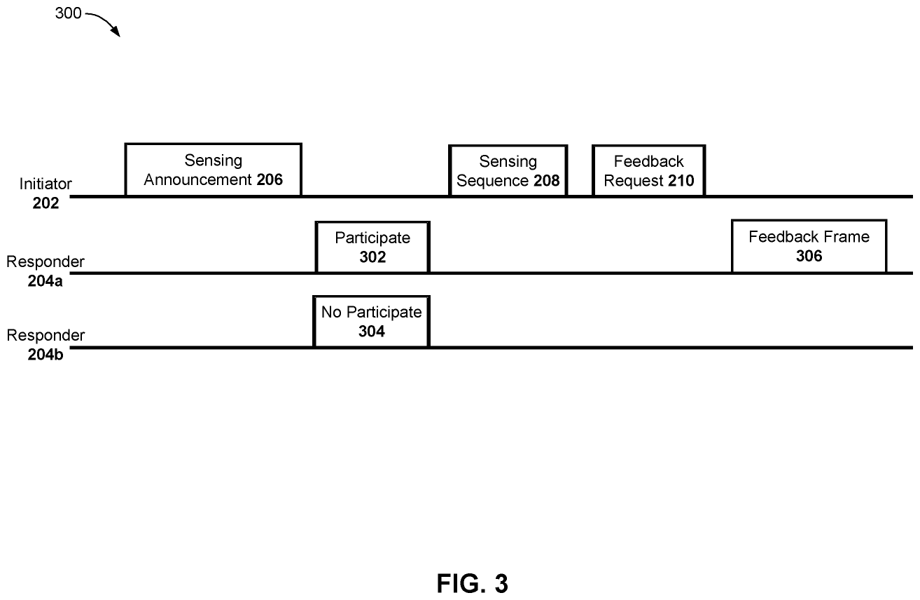

FIG. 3 depicts a call flow 300 in accordance with embodiments of the present disclosure, wherein indications to participate or not participate are sent before the broadcasting of the sensing sequence frame 208. Similar to FIG. 2, a sensing initiator 200 broadcasts a sensing announcement 206. Then, sensing responders 204a and 204b send their respective indications to participate or not participate to the sensing initiator 202. In call flow 300, sensing responder 204a sends an indication 302 to participate, while sensing responder 204b sends an indication 304 to not participate. Then, sensing initiator 202 transmits a sensing sequence frame 208, followed by transmitting a feedback request frame 210 to the sensing responders which have indicated a willingness to participate. Sensing responder 204a then sends a feedback frame 306 to sensing initiator 202. It will be understood that this embodiment allows for a reduction of resource unit (RU) allocation overhead by informing the sensing initiator 202 which responders will be participating.

In the embodiment illustrated in FIG. 3, as the sensing initiator knows which sensing responder will be participating, the sensing initiator is able to tailor the transmission of the sensing sequence and feedback request frame in order that it is only sent to the participating responders, which may result in a saving of network resources. It is also understood, that in some embodiments, the sensing initiator may broadcast the sensing sequence and feedback request frame to the sensing responders regardless of the prior knowledge of the respective participation or non-participation thereof. The broadcasting or the tailored transmission of the sensing sequence and the feedback request frame my be determined by the sensing initiator when considering the cost benefit of broadcasting or tailored transmission depending on the number of participating and non-participating sensing responders.

In some embodiments the at least one of the indication to participate and the indication to not participate is sent after the broadcasting of the sensing sequence frame 208. This provision of the sensing sequence frame 208 prior to the transmission of the indication, can provide the responder stations with knowledge of the sensing sequence frame 208 prior to electing whether they wish to participate or not participate in the sensing session.

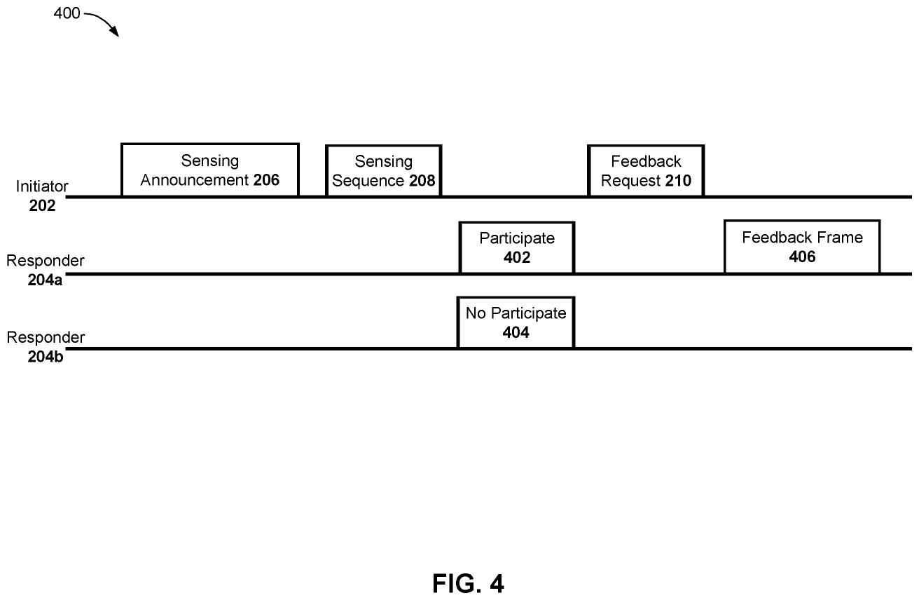

FIG. 4 depicts a call flow 400 according to embodiments of the present disclosure, in which indications to participate or not participate are sent after the broadcasting of the sensing sequence frame. Similar to FIG. 2, a sensing initiator 200 broadcasts a sensing announcement 206, followed by broadcasting a sensing sequence frame 208. Then, sensing responders 204a and 204b send their respective indications to participate or not participate to the sensing initiator 202. In call flow 400, similar to call flow 300, sensing responder 204a sends an indication 402 to participate, while sensing responder 204b sends an indication 404 to not participate. Then, sensing initiator 202 transmits a feedback request frame 210. Sensing responder 204a then sends a feedback frame 406 to sensing initiator 202.

As with FIG. 2, it will be reasonably understood that the number of sensing responders associated with embodiments of the present disclosure, may vary in any given network or at any point in time associated with a particular network.

In some embodiments the feedback type of the sensed measurements includes channel state information (CSI). In some embodiments, the type of feedback provided by a sensing responder depends on the measured values. For example, if the measured values are significantly different (e.g. the difference exceeds a pre-defined threshold value) from the previously measured values, the sensing responder feeds back the newly measured values to the sensing initiator in a “Sensing Measurement Feedback” action field. However, if the measured values are within a pre-defined threshold value, the sensing responder sends to the sensing initiator an indication that no new values are to be reported in a “No Measurements Are Reported” action field.

In some embodiments the feedback type of the sensed measurements includes angle of arrival (AoA) and/or angle of departure (AoD). AoA and AoD may be estimated using spatial diversity (e.g phase difference between different sensors, for example, multiple antennas) via CSI measurement for the location (e.g. direction) associated with the sensing responder. AoA and AoD measurement result formats have been defined in the 802.11 standard, which include: AoA/AoD Azimuth (in 360°/2048 resolution); AoA/AoD Azimuth Accuracy; AoA/AoD Elevation (in 180°/1024 resolution); and AoA/AoD Elevation Accuracy. In a sensing measurement information element (IE), the information related to AoA and AoD may be included, wherein the measured angle information that is being fed back to the sensing initiator is a real number.

In some embodiments the feedback type of the sensed measurements includes time of flight (ToF). ToF is a parameter that may be used to estimate the position of an object by measuring the distance to an object through considering the phase shift between subcarriers as a function of ToF in order to reformulate the steering matrix of a transmission. In this way, both antennas and subcarriers may be treated as sensors. In a sensing measurement IE, the information related to ToF on the subcarriers may be included, in which the measured time information that is being fed back to the sensing initiator is a real number.

In some embodiments the feedback type of the sensed measurements includes time of arrival (ToA) and/or time of departure (ToD). ToA and ToD are other possible sensing measurements if timestamp is considered. In a sensing measurement IE, the information related to ToA and ToD on the subcarriers may be included, in which the measured time information to be fed back is real number.

In some embodiments the sensing initiator station may be an access point station. In other embodiments the sensing initiator may be a non-access point station. The sensing initiator may initiate the sensing procedure and determine which devices (for example, one or more sensing responders) may be requested to send one or more of sensing frames and sensing feedback. The one or more sensing responders may be a Wi-Fi station capable of performing sensing actions as described herein.

In some embodiments the reference sequence associated with a sensing sequence frame is used by a participating station in order to estimate channel state information (CSI). The reference sequence may be alternately or additionally be used by one or more participating stations to estimate one or more of angle of arrival (AoA), angle of departure (AoD), time of flight (ToF), time of arrival (ToA) and time of departure (ToD).

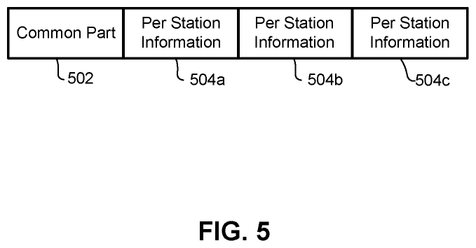

In some embodiments the feedback request frame is a trigger frame. For example, a feedback request frame may be used to exclude non-participating responder stations. FIG. 5 depicts a common structure of a feedback request (e.g. trigger) frame. A feedback request frame includes a common part 502 and one or more station information portions. In FIG. 5, there are three station information portions depicted, namely station information portions 504a, 504b and 504c. Each station information field contains information relevant to a particular responder station including, for example, resource unit (RU) allocation, modulation and coding scheme (MCS), or other relevant specific responder station information. When a responder station (or sensing responder) indicates that it does not wish to participate in a sensing session, the sensing initiator removes that particular responder from the list defined in the station information fields that are present in the feedback request frame.

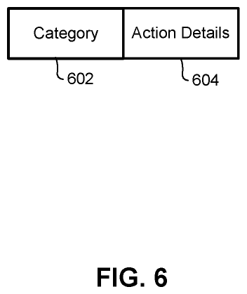

In some embodiments the feedback frame is an action frame. An action frame is defined in the 802.11 standard, and is depicted in FIG. 6, with each category 602 (to identify the type of the action frame present) and the corresponding action details 604. There are several action frame categories defined in the 802.11 standard, including quality of service (QoS), very high throughput (VHT) and spectrum management. Embodiments of the present disclosure further define a further action category action herein referred to as “sensing”. An action frame defined using the “sensing” can be configured to carry actions or information relevant to the Wi-Fi sensing process.

In some embodiments the feedback frame includes several types of feedback in order to indicate the type of feedback the sensing responder is transmitting to the sensing initiator. Various feedback types are shown in TABLE 1 below with an associated order number, which as an example may be defined by an eight bit sequence:

TABLE 1

| Order | Information |
|---|---|
| 0 | Sensing Measurements Feedback |
| 1 | No Measurements Are Reported |
| 2 | Participate/No Participate |
| 4-255 | Reserved-Other sensing related frames |

Having particular regard to TABLE 1, “Sensing Measurements Feedback” can be used to indicate that measurements are included in the frame. “No Measurements Are Reported” can be used to indicate that the sensing responder is not reporting any measurements at the particular time. No measurements may be result of the sensing responder not able to perform the required measurements or that changes in the measurements relative to the previously provided measurements are insignificant (e.g. do not exceed a predefined threshold) and may be ignored. “Participate/No Participate” can be used at the sensing session setup in order to indicate whether ability of the sensing responder will participate or not participate in the sensing session. For example, the determination of participating or not participating may be determined based on the abilities of the sensing responder or status of the sensing responder. “Sensing Measurements Feedback” may be further defined by a “Measurement Type” subfield, which may be used to indicate the type of measurements that are being transmitted or fed back by the sensing responder to the sensing initiator.

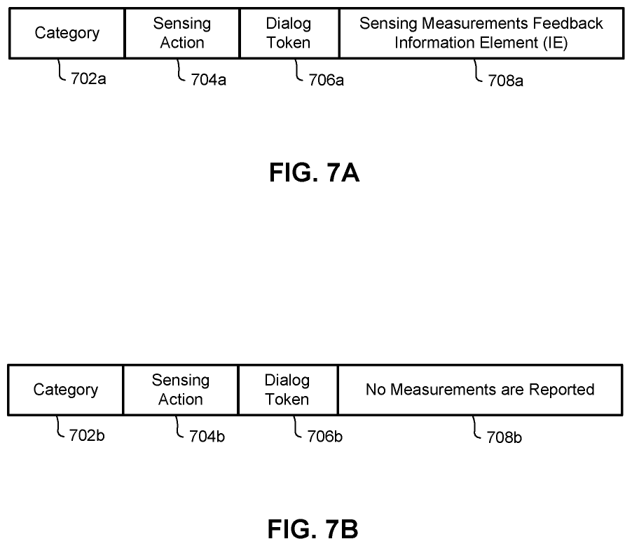

FIGS. 7A and 7B depict example action frame formats. In both of FIGS. 7A and 7B, there is a category field 702a and 702b, a sensing action field 704a and 704b, a dialog token field 706a and 706b and an information field 708a and 708b. In FIG. 7A, the information field 708a contains a sensing measurements feedback information element (IE), indicating that there is sensing measurements feedback information in the field. In contrast, the information field 708b of FIG. 7B indicates that no measurements are reported.

In some embodiments the sensing announcement frame is a null data packet announcement (NDPA) frame. As may be appreciated by a person skilled in the art, in the mainstream 802.11 (e.g., 11 ac, 11ax, 11be), the NDPA sounding dialog token field may follow the MAC header field (e.g. in the NDPA frame). The sounding dialog token field may include, for example, eight bits. The first two bits of the sounding dialog token field may be used to indicate the NDPA version, while the remaining six bits may be used to indicate the session of the NDPA. For example, the first two bits, may be used to indicate very high throughput (VHT) NDPA, high efficiency (HE) NDPA (11ax NDPA), ranging NDPA (11az NDPA), and extremely high throughput (EHT) NDPA (11be NDPA). Accordingly, the first two bits of the sounding dialog token field is already consumed and may no longer be used for any other indication.

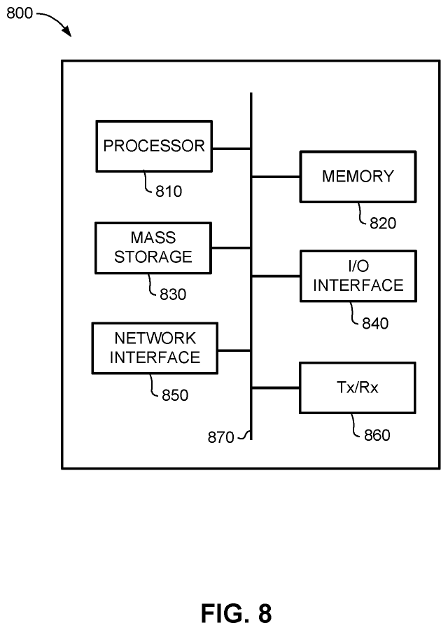

FIG. 8 is a schematic diagram of an electronic device 800 that may perform any or all of the steps of the above methods and features described herein, according to different embodiments of the present disclosure. For example, a user equipment (UE), base transceiver station (BTS), base station, wireless gateway or mobility router may be configured as the electronic device. It may be noted that the term “BTS” or “base station” refers to an evolved NodeB (eNB), new radio (NR) or next generation NodeB (gNodeB or gNB), a radio access node, or another device in a wireless communication network infrastructure, such as a long term evolution (LTE) infrastructure, NR or 5G infrastructure, which performs or directs at least some aspects of wireless communication with wireless communication devices. The term “UE” refers to a device, such as a mobile device, machine-type-communication (MTC) device, machine-to-machine (M2M) equipment, internet of things (IoT) device, internet of vehicles (IoV) device or other device, which accesses the wireless communication network infrastructure via wireless communication with a base station.

As shown, the device includes a processor 810, memory 820, non-transitory mass storage 830, I/O interface 840, network interface 850, and a transceiver 860, all of which are communicatively coupled via bi-directional bus 870. According to certain embodiments, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus.

The memory 820 may include any type of non-transitory or non-transient memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the methods described herein can be implemented as coded instructions in a computer program product. In other words, the computer program product is a computer-readable medium upon which software code is recorded to execute the methods when the computer program product is loaded into memory and executed on the microprocessor of the wireless communication device.

Acts associated with the methods described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the methods may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

We claim:

1. A method, at a sensing initiator station, of soliciting and obtaining measurement feedback, the method comprising:
broadcasting, by the sensing initiator station, a sensing announcement frame;
broadcasting, by the sensing initiator station, a sensing sequence frame, the sensing sequence frame containing a reference sequence;
transmitting, by the sensing initiator station, a feedback request frame, the feedback request frame including station information indicating resources allocated for each of one or more responder stations;
receiving, by the sensing initiator station from at least one of the one or more responder stations, a feedback frame, the feedback frame including an indicator corresponding to data contained in the feedback frame.

2. The method of claim 1 further comprising receiving by the sensing initiator station from at least one of the one or more responder stations, at least one of:
an indication to participate, from a participating station; and
an indication to not participate, from a non-participating station.

3. The method of claim 2 wherein at least one of the indication to participate and the indication to not participate is received before the broadcasting of the sensing sequence frame or after the broadcasting of the sensing sequence frame.

4. The method of claim 1 wherein the sensing initiator station is one of:
an access point station; and
a non-access point station.

5. The method of claim 1 wherein the sensing announcement frame includes at least one station ID for at least one station.

6. The method of claim 2 wherein the reference sequence is used by the participating station to estimate at least one of:
channel state information (CSI);
angle of arrival (AoA);
angle of departure (AoD);
time of flight (ToF);
time of arrival (ToA); and
time of departure (ToD).

7. The method of claim 1 wherein the feedback request frame is a trigger frame.

8. The method of claim 1 wherein the feedback frame is an action frame.

9. The method of claim 1 wherein the feedback frame includes at least one of:
sensing measurements feedback;
an indication that no measurements are reported;
an indication to participate; and
an indication to not participate.

10. The method of claim 1 wherein the sensing announcement frame is a null data packet announcement (NDPA) frame.

11. A device comprising:
a processor; and
non-transitory computer readable memory having stored thereon machine readable instructions which when executed by the processor configure the device to:
broadcast a sensing announcement frame;
broadcast a sensing sequence frame, the sensing sequence frame containing a reference sequence;
transmit a feedback request frame, the feedback request frame including station information indicating resources allocated for each of one or more responder stations;
receive a feedback frame from at least one of the one or more responder stations, the feedback frame including an indicator corresponding to data contained in the feedback frame.

12. The device of claim 11 further configured to receive, from the responder station, at least one of:
an indication to participate; and
an indication to not participate.

13. The device of claim 12 wherein the at least one of the indication to participate and the indication to not participate is sent one of:
before the broadcast of the sensing sequence frame; and
after the broadcast of the sensing sequence frame.

14. The device of claim 11 wherein the device is one of:
an access point station; and
a non-access point station.

15. The device of claim 11 wherein the sensing announcement frame includes at least one station ID for at least one station.

16. The device of claim 11 wherein the reference sequence is used by a participating station to estimate at least one of:
channel state information (CSI);
angle of arrival (AoA);
angle of departure (AoD);
time of flight (ToF);
time of arrival (ToA); and
time of departure (ToD).

17. The device of claim 11 wherein the feedback request frame is a trigger frame.

18. The device of claim 11 wherein the feedback frame is an action frame.

19. The device of claim 11 wherein the feedback frame includes at least one of:
sensing measurements feedback;
an indication that no measurements are reported;
an indication to participate; and
an indication to not participate.

20. The device of claim 11 wherein the sensing announcement frame is a null data packet announcement (NDPA) frame.
